(19) United States
(12) Patent Application Publication
(10) Pub. No.: US 2026/0074935 A1
(43) Pub. Date: Mar. 12, 2026

(54) AUTONOMOUS TIMING ADVANCE ADJUSTMENT FOR MULTIPLE TRANSMISSION RECEPTION POINTS

(71) Applicant: QUALCOMM Incorporated, San Diego, CA (US)

(72) Inventors: Yan ZHOU, San Diego, CA (US); Fang YUAN, Beijing (CN); Mostafa KHOSHNEVISAN, San Diego, CA (US); Shaozhen GUO, Beijing (CN); Tao LUO, San Diego, CA (US)

(21) Appl. No.: 18/871,352

(22) PCT Filed: Jul. 14, 2022
(86) PCT No.: PCT/CN2022/105647

§ 371 Date: Dec. 3, 2024

(51) Int. Cl. H04L 27/26; H04W 76/38

(52) U.S. Cl. CPC H04L 27/261; H04W 76/38

(57) ABSTRACT

Various aspects of the present disclosure generally relate to wireless communication. In some aspects, a user equipment (UE) may receive, from a first transmission reception point (TRP), a first reference signal. The UE may receive, from a second TRP, a second reference signal. The UE may perform an autonomous timing advance adjustment procedure by autonomously adjusting a first timing advance parameter associated with the first TRP based at least in part on a measurement associated with the first reference signal and autonomously adjusting a second timing advance parameter associated with the second TRP based at least in part on a measurement associated with the second reference signal. Numerous other aspects are described.

### FIELD OF THE DISCLOSURE

Aspects of the present disclosure generally relate to wireless communication and to techniques and apparatuses for autonomous timing advance adjustment for multiple transmission reception points.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving, from a first transmission reception point (TRP), a first reference signal. The method may include receiving, from a second TRP, a second reference signal. The method may include performing an autonomous timing advance adjustment procedure by autonomously adjusting a first timing advance parameter associated with the first TRP based at least in part on a measurement associated with the first reference signal and autonomously adjusting a second timing advance parameter associated with the second TRP based at least in part on a measurement associated with the second reference signal.

Some aspects described herein relate to a method of wireless communication performed by a network node. The method may include transmitting, to a UE, a reference signal configuration associated with a TRP. The method may include transmitting, to the UE, a reference signal based at least in part on the reference signal configuration. The method may include receiving, from the UE, a communication, wherein a timing of the communication is based at least in part on a multi-TRP autonomous timing advance adjustment procedure performed by the UE.

Some aspects described herein relate to an apparatus for wireless communications at a UE. The apparatus may include a processor, memory coupled with the processor, and instructions stored in the memory and executable by the processor. The instructions, when executed by the processor, may cause the apparatus to receive, from a first TRP, a first reference signal. The instructions, when executed by the processor, may further cause the apparatus to receive, from a second TRP, a second reference signal. The instructions, when executed by the processor, may further cause the apparatus to perform an autonomous timing advance adjustment procedure by autonomously adjusting a first timing advance parameter associated with the first TRP based at least in part on a measurement associated with the first reference signal and autonomously adjusting a second timing advance parameter associated with the second TRP based at least in part on a measurement associated with the second reference signal.

Some aspects described herein relate to an apparatus for wireless communications at a network node. The apparatus may include a processor, memory coupled with the processor, and instructions stored in the memory and executable by the processor. The instructions, when executed by the processor, may cause the apparatus to transmit, to a UE, a reference signal configuration associated with a TRP. The instructions, when executed by the processor, may further cause the apparatus to transmit, to the UE, a reference signal based at least in part on the reference signal configuration. The instructions, when executed by the processor, may further cause the apparatus to receive, from the UE, a communication, wherein a timing of the communication is based at least in part on a multi-TRP autonomous timing advance adjustment procedure performed by the UE.

Some aspects described herein relate to a non-transitory computer-readable medium that stores a set of instructions for wireless communication by a UE. The set of instructions, when executed by one or more processors of the UE, may cause the UE to receive, from a first TRP, a first reference signal. The set of instructions, when executed by one or more processors of the UE, may cause the UE to receive, from a second TRP, a second reference signal. The set of instructions, when executed by one or more processors of the UE, may cause the UE to perform an autonomous timing advance adjustment procedure by autonomously adjusting a first timing advance parameter associated with the first TRP based at least in part on a measurement associated with the first reference signal and autonomously adjusting a second timing advance parameter associated with the second TRP based at least in part on a measurement associated with the second reference signal.

Some aspects described herein relate to a non-transitory computer-readable medium that stores a set of instructions for wireless communication by a network node. The set of instructions, when executed by one or more processors of the network node, may cause the network node to transmit, to a UE, a reference signal configuration associated with a TRP. The set of instructions, when executed by one or more processors of the network node, may cause the network node to transmit, to the UE, a reference signal based at least in part on the reference signal configuration. The set of instructions, when executed by one or more processors of the network node, may cause the network node to receive, from the UE, a communication, wherein a timing of the communication is based at least in part on a multi-TRP autonomous timing advance adjustment procedure performed by the UE.

Some aspects described herein relate to an apparatus for wireless communication. The apparatus may include means for receiving, from a first TRP, a first reference signal. The apparatus may include means for receiving, from a second TRP, a second reference signal. The apparatus may include means for performing an autonomous timing advance adjustment procedure by autonomously adjusting a first timing advance parameter associated with the first TRP based at least in part on a measurement associated with the first reference signal and autonomously adjusting a second timing advance parameter associated with the second TRP based at least in part on a measurement associated with the second reference signal.

Some aspects described herein relate to an apparatus for wireless communication. The apparatus may include means for transmitting, to a UE, a reference signal configuration associated with a TRP. The apparatus may include means for transmitting, to the UE, a reference signal based at least in part on the reference signal configuration. The apparatus may include means for receiving, from the UE, a communication, wherein a timing of the communication is based at least in part on a multi-TRP autonomous timing advance adjustment procedure performed by the UE.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 illustrates an example logical architecture of a distributed radio access network, in accordance with the present disclosure.

FIG. 5 is a diagram illustrating an example of multi-transmission-reception-point (multi-TRP) communication, in accordance with the present disclosure.

FIG. 6 is a diagram illustrating an example of TRP differentiation at a UE based at least in part on a control resource set pool index, in accordance with the present disclosure.

FIG. 7 is a diagram illustrating an example of downlink and uplink transmissions between a network node and a UE in a wireless network, in accordance with the present disclosure.

FIG. 8 is a diagram of an example associated with autonomous timing advance adjustment for multiple TRPs, in accordance with the present disclosure.

FIG. 9 is a diagram illustrating an example process performed, for example, by a UE, in accordance with the present disclosure.

FIG. 10 is a diagram illustrating an example process performed, for example, by a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

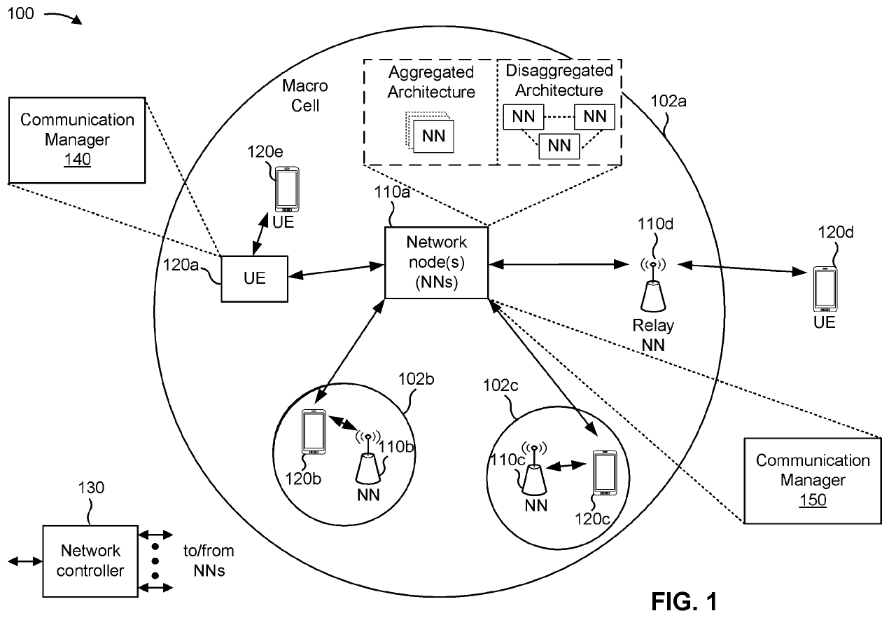

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a first TRP, a first reference signal; receive, from a second TRP, a second reference signal; and perform an autonomous timing advance adjustment procedure by autonomously adjusting a first timing advance parameter associated with the first TRP based at least in part on a measurement associated with the first reference signal and autonomously adjusting a second timing advance parameter associated with the second TRP based at least in part on a measurement associated with the second reference signal. Additionally, or alternatively, the communication manager 140 may perform one or more other operations described herein.

In some aspects, the network node 110 may include a communication manager 150. As described in more detail elsewhere herein, the communication manager 150 may transmit, to a UE (e.g., the UE 120), a reference signal configuration associated with a TRP; transmit, to the UE, a reference signal based at least in part on the reference signal configuration; and receive, from the UE, a communication, wherein a timing of the communication is based at least in part on a multi-TRP autonomous timing advance adjustment procedure performed by the UE. Additionally, or alternatively, the communication manager 150 may perform one or more other operations described herein.

As indicated above, FIG. 1 is provided as an example. Other examples may differ from what is described with regard to FIG. 1.

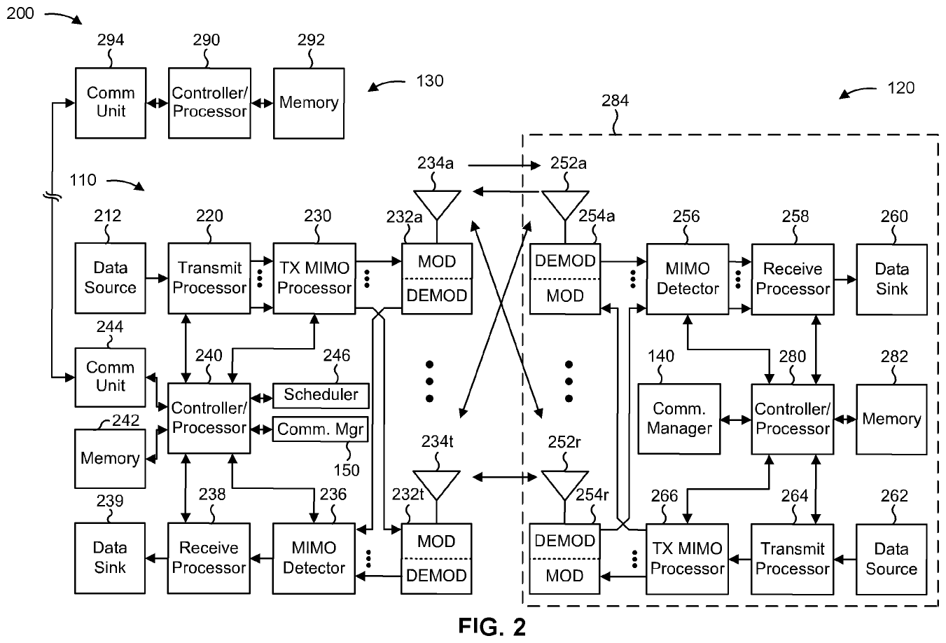

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

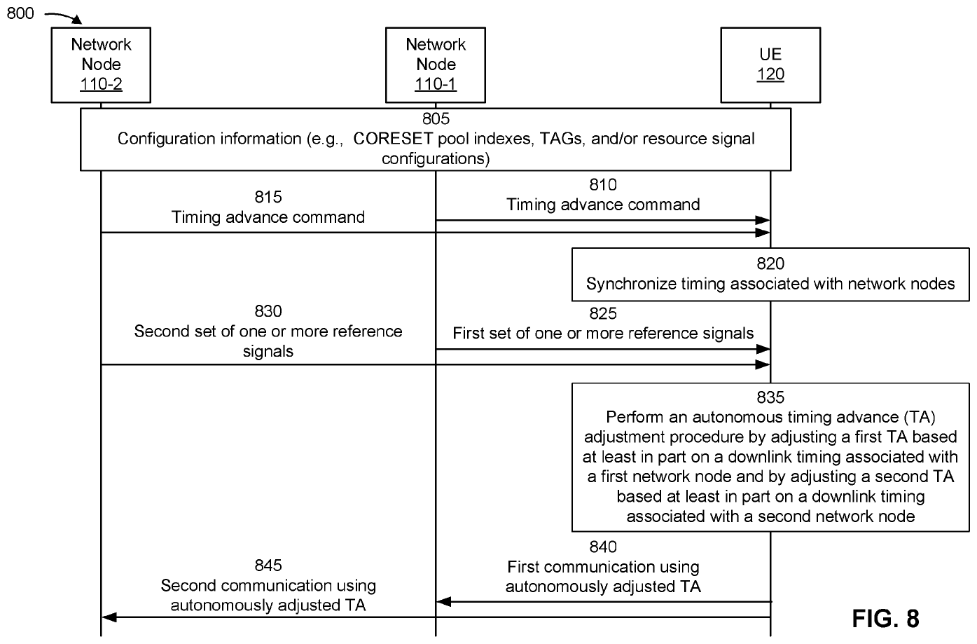

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 8-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 8-12).

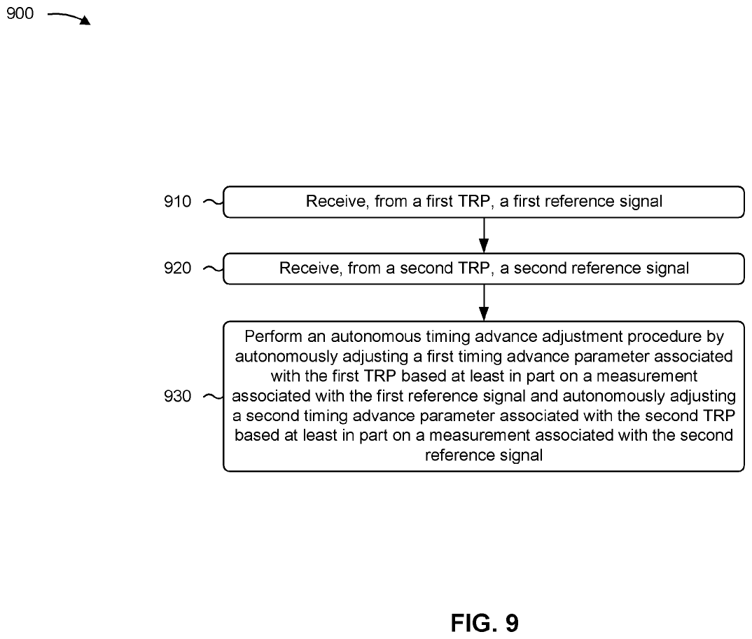

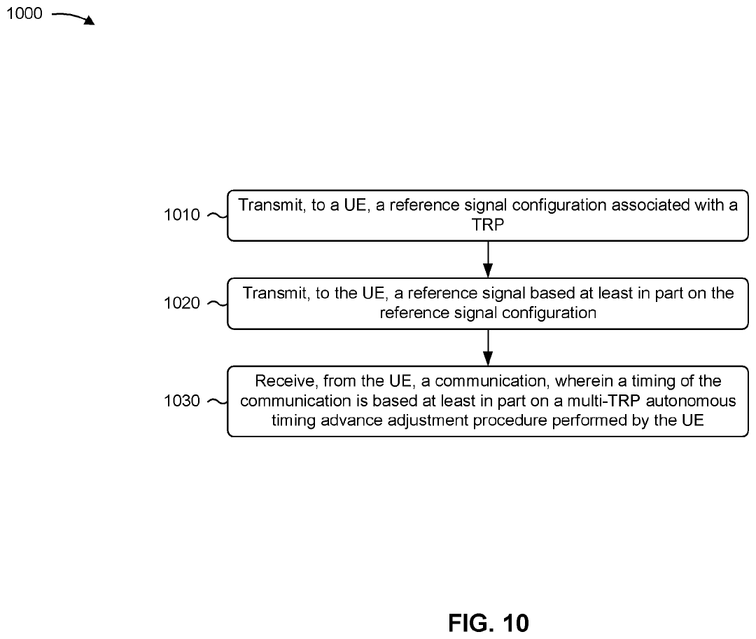

The controller/processor 240 of the network node 110, the controller/processor 280 of the UE 120, and/or any other component(s) of FIG. 2 may perform one or more techniques associated with autonomous timing advance adjustment for multiple TRPs, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for receiving, from a first TRP, a first reference signal; means for receiving, from a second TRP, a second reference signal; and/or means for performing an autonomous timing advance adjustment procedure by autonomously adjusting a first timing advance parameter associated with the first TRP based at least in part on a measurement associated with the first reference signal and autonomously adjusting a second timing advance parameter associated with the second TRP based at least in part on a measurement associated with the second reference signal. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, to a UE (e.g., the UE 120), a reference signal configuration associated with a TRP; means for transmitting, to the UE, a reference signal based at least in part on the reference signal configuration; and/or means for receiving, from the UE, a communication, wherein a timing of the communication is based at least in part on a multi-TRP autonomous timing advance adjustment procedure performed by the UE. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

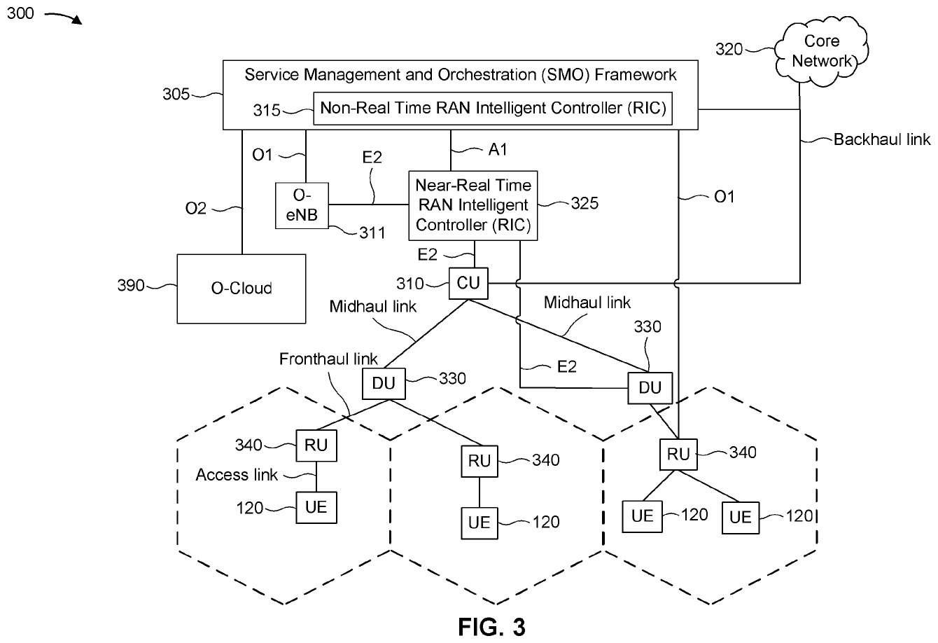

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

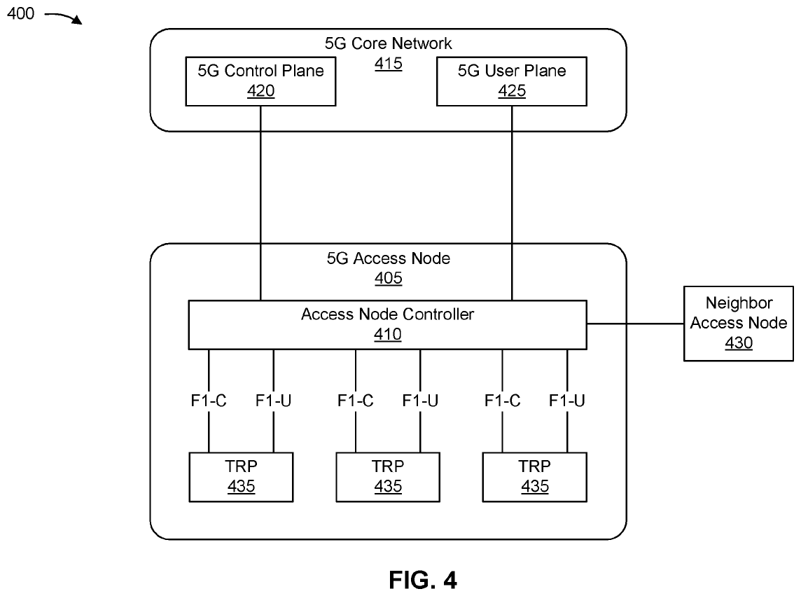

FIG. 4 illustrates an example logical architecture of a distributed RAN 400, in accordance with the present disclosure.

A 5G access node 405 may include an access node controller 410. The access node controller 410 may be a CU of the distributed RAN 400. In some aspects, a backhaul interface to a 5G core network 415 may terminate at the access node controller 410. The 5G core network 415 may include a 5G control plane component 420 and a 5G user plane component 425 (e.g., a 5G gateway), and the backhaul interface for one or both of the 5G control plane and the 5G user plane may terminate at the access node controller 410. Additionally, or alternatively, a backhaul interface to one or more neighbor access nodes 430 (e.g., another 5G access node 405 and/or an LTE access node) may terminate at the access node controller 410.

The access node controller 410 may include and/or may communicate with one or more TRPs 435 (e.g., via an F1 Control (F1-C) interface and/or an F1 User (F1-U) interface). A TRP 435 may be a DU of the distributed RAN 400. In some aspects, a TRP 435 may correspond to a network node 110 described above in connection with FIG. 1. For example, different TRPs 435 may be included in different network nodes 110. Additionally, or alternatively, multiple TRPs 435 may be included in a single network node 110. In some aspects, a network node 110 may include a CU (e.g., access node controller 410) and/or one or more DUs (e.g., one or more TRPs 435). In some cases, a TRP 435 may be referred to as a cell, a panel, an antenna array, or an array.

A TRP 435 may be connected to a single access node controller 410 or to multiple access node controllers 410. In some aspects, a dynamic configuration of split logical functions may be present within the architecture of distributed RAN 400. For example, a packet data convergence protocol (PDCP) layer, a radio link control (RLC) layer, and/or a medium access control (MAC) layer may be configured to terminate at the access node controller 410 or at a TRP 435.

In some aspects, multiple TRPs 435 may transmit communications (e.g., the same communication or different communications) in the same transmission time interval (TTI) (e.g., a slot, a mini-slot, a subframe, or a symbol) or different TTIs using different quasi co-location (QCL) relationships (e.g., different spatial parameters, different transmission configuration indicator (TCI) states, different precoding parameters, and/or different beamforming parameters). In some aspects, a TCI state may be used to indicate one or more QCL relationships. A TRP 435 may be configured to individually (e.g., using dynamic selection) or jointly (e.g., using joint transmission with one or more other TRPs 435) serve traffic to a UE 120.

As indicated above, FIG. 4 is provided as an example. Other examples may differ from what was described with regard to FIG. 4.

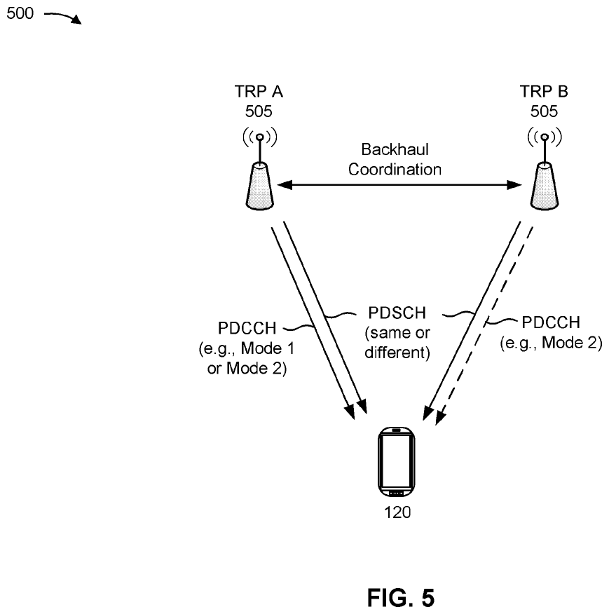

FIG. 5 is a diagram illustrating an example 500 of multi-TRP communication (sometimes referred to as multi-panel communication), in accordance with the present disclosure. As shown in FIG. 5, multiple TRPs 505 may communicate with the same UE 120. A TRP 505 may correspond to a TRP 435 described above in connection with FIG. 4.

The multiple TRPs 505 (shown as TRP A and TRP B) may communicate with the same UE 120 in a coordinated manner (e.g., using coordinated multipoint transmissions) to improve reliability and/or increase throughput. The TRPs 505 may coordinate such communications via an interface between the TRPs 505 (e.g., a backhaul interface and/or an access node controller 410). The interface may have a smaller delay and/or higher capacity when the TRPs 505 are co-located at the same network node 110 (e.g., when the TRPs 505 are different antenna arrays or panels of the same network node 110), and may have a larger delay and/or lower capacity (as compared to co-location) when the TRPs 505 are located at different network nodes 110. The different TRPs 505 may communicate with the UE 120 using different QCL relationships (e.g., different TCI states), different DMRS ports, and/or different layers (e.g., of a multi-layer communication).

In a first multi-TRP transmission mode (e.g., Mode 1), a single physical downlink control channel (PDCCH) may be used to schedule downlink data communications for a single physical downlink shared channel (PDSCH). In this case, multiple TRPs 505 (e.g., TRP A and TRP B) may transmit communications to the UE 120 on the same PDSCH. For example, a communication may be transmitted using a single codeword with different spatial layers for different TRPs 505 (e.g., where one codeword maps to a first set of layers transmitted by a first TRP 505 and maps to a second set of layers transmitted by a second TRP 505). As another example, a communication may be transmitted using multiple codewords, where different codewords are transmitted by different TRPs 505 (e.g., using different sets of layers). In either case, different TRPs 505 may use different QCL relationships (e.g., different TCI states) for different DMRS ports corresponding to different layers. For example, a first TRP 505 may use a first QCL relationship or a first TCI state for a first set of DMRS ports corresponding to a first set of layers, and a second TRP 505 may use a second (different) QCL relationship or a second (different) TCI state for a second (different) set of DMRS ports corresponding to a second (different) set of layers. In some aspects, a TCI state in downlink control information (DCI) (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 505, and a second PDCCH may schedule a second codeword to be transmitted by a second TRP 505. Furthermore, first DCI (e.g., transmitted by the first TRP 505) may schedule a first PDSCH communication associated with a first set of DMRS ports with a first QCL relationship (e.g., indicated by a first TCI state) for the first TRP 505, and second DCI (e.g., transmitted by the second TRP 505) may schedule a second PDSCH communication associated with a second set of DMRS ports with a second QCL relationship (e.g., indicated by a second TCI state) for the second TRP 505. In this case, DCI (e.g., having DCI format 1_0 or DCI format 1_1) may indicate a corresponding TCI state for a TRP 505 corresponding to the DCI. The TCI field of a DCI indicates the corresponding TCI state (e.g., the TCI field of the first DCI indicates the first TCI state and the TCI field of the second DCI indicates the second TCI state).

As indicated above, FIG. 5 is provided as an example. Other examples may differ from what is described with respect to FIG. 5.

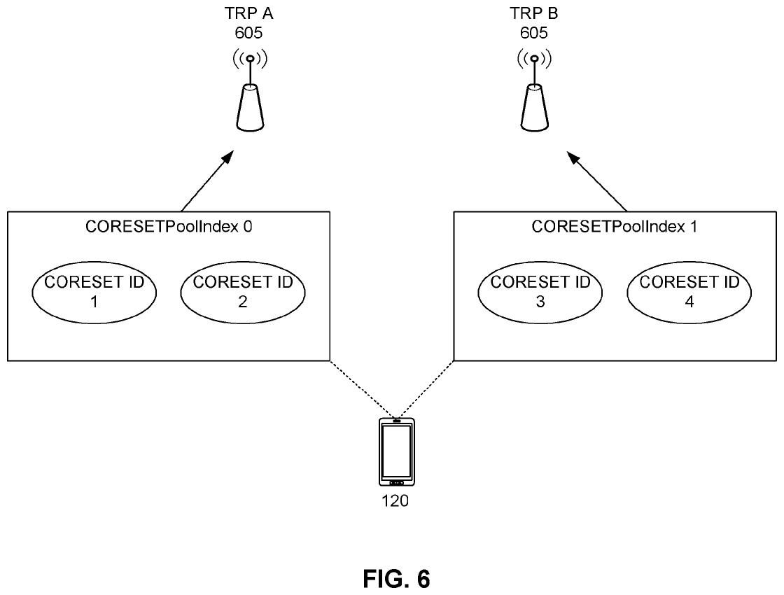

FIG. 6 is a diagram illustrating an example of TRP differentiation at a UE based at least in part on a control resource set (CORESET) pool index, in accordance with the present disclosure. In some aspects, a CORESET pool index (or CORESETPoolIndex) value may be used by a UE 120 to identify a TRP associated with an uplink grant received on a PDCCH.

“CORESET” may refer to a control region that is structured to support an efficient use of resources, such as by flexible configuration or reconfiguration of resources for one or more PDCCHs associated with a UE. In some aspects, a CORESET may occupy the first symbol of an orthogonal frequency division multiplexing (OFDM) slot, the first two symbols of an OFDM slot, or the first three symbols of an OFDM slot. Thus, a CORESET may include multiple resource blocks (RBs) in the frequency domain, and either one, two, or three symbols in the time domain. In 5G, a quantity of resources included in a CORESET may be flexibly configured, such as by using RRC signaling to indicate a frequency domain region (for example, a quantity of resource blocks) or a time domain region (for example, a quantity of symbols) for the CORESET.

As illustrated in FIG. 6, a UE 120 may be configured with multiple CORESETs in a given serving cell. Each CORESET configured for the UE 120 may be associated with a CORESET identifier (CORESET ID). For example, a first CORESET configured for the UE 120 may be associated with CORESET ID 1, a second CORESET configured for the UE 120 may be associated with CORESET ID 2, a third CORESET configured for the UE 120 may be associated with CORESET ID 3, and a fourth CORESET configured for the UE 120 may be associated with CORESET ID 4.

As further illustrated in FIG. 6, two or more (for example, up to five) CORESETs may be grouped into a CORESET pool. Each CORESET pool may be associated with a CORESET pool index. As an example, CORESET ID 1 and CORESET ID 2 may be grouped into CORESET pool index 0, and CORESET ID 3 and CORESET ID 4 may be grouped into CORESET pool index 1. In a multi-TRP configuration, each CORESET pool index value may be associated with a particular TRP 605. As an example, and as illustrated in FIG. 6, a first TRP 605 (TRP A) may be associated with CORESET pool index 0 and a second TRP 605 (TRP B) may be associated with CORESET pool index 1. The UE 120 may be configured by a higher layer parameter, such as PDCCH-Config, with information identifying an association between a TRP and a CORESET pool index value assigned to the TRP. Accordingly, the UE may identify the TRP that transmitted a DCI uplink grant by determining the CORESET ID of the CORESET in which the PDCCH carrying the DCI uplink grant was transmitted, determining the CORESET pool index value associated with the CORESET pool in which the CORESET ID is included, and identifying the TRP associated with the CORESET pool index value.

As indicated above, FIG. 6 is provided as an example. Other examples may differ from what is described with respect to FIG. 6.

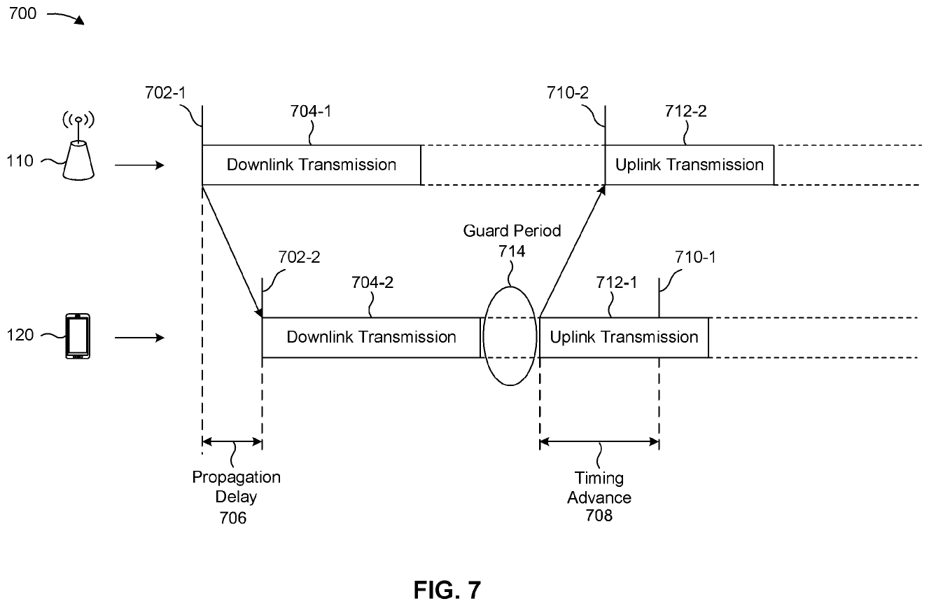

FIG. 7 is a diagram illustrating an example 700 of downlink and uplink transmissions between a network node 110 and a UE 120 in a wireless network 100, in accordance with the present disclosure. In some examples, the downlink and/or uplink transmissions are based at least in part on a timing advance and/or a guard period between communications. As one example, a network node 110 may configure a downlink transmission to end before the start of a guard period. As another example, the UE 120 may advance a start time for an uplink transmission based at least in part on a timing advance.

As shown by reference number 702-1, a network node 110 may begin a downlink transmission 704-1 to a UE 120 at a first point in time. In some examples, the first point in time may be based at least in part on a timing scheme defined by a telecommunication system and/or telecommunication standard. To illustrate, the telecommunication standard may define various time partitions for scheduling transmissions between devices. As one example, the timing scheme may define radio frames (sometimes referred to as frames), where each radio frame has a predetermined duration (e.g., 10 milliseconds (msec)). Each radio frame may be further partitioned into a set of Z (Z≥1) subframes, where each subframe may have a predetermined duration (e.g., 1 msec). Each subframe may be further partitioned into a set of slots and/or each slot may include a set of L symbol periods (e.g., fourteen symbol periods, seven symbol periods, or another number of symbol periods). Thus, the first point in time as shown by the reference number 702-1 may be based at least in part on a time partition as defined by a telecommunication system (e.g., a frame, a subframe, a slot, a mini-slot, and/or a symbol).

In some examples, the network node 110 and the UE 120 may wirelessly communicate with one another (e.g., directly or via one or more network nodes) based at least in part on the defined time partitions. However, each device may have different timing references for the time partitions. To illustrate, and as shown by the reference number 702-1, the network node 110 may begin the downlink transmission 704-1 at a particular point in time that may be associated with a defined time partition based at least in part on a time perspective of the network node 110. For example, the network node 110 may associate the particular point in time with a defined time partition, such as a beginning of a symbol, a beginning of a slot, a beginning of a subframe, and/or a beginning of a frame. However, the downlink transmission may incur a propagation delay 706 in time, such as a time delay based at least in part on the downlink transmission traveling between a network node 110 (e.g., an RU, a TRP, or the like) and the UE 120. As shown by reference number 702-2, the UE 120 may receive downlink transmission 704-2 (corresponding to downlink transmission 704-1 transmitted by the network node 110) at a second point in time that is later in time relative to the first point in time. From a time perspective of the UE 120, however, the UE 120 may associate the second point in physical time shown by the reference number 702-2 with the same particular point in time of the defined time partition as the network node 110 (e.g., a beginning of the same symbol, a beginning of the same mini-slot, a beginning of the same slot, a beginning of the same subframe, and/or a beginning of the same frame). Thus, as shown by the example 700, the time perspective of the UE 120 may be delayed in time from the time perspective of the network node 110.

In wireless communication technologies like 4G/LTE and 5G/NR, a timing advance (TA) value is used to control a timing of uplink transmissions by a UE 120 such that the uplink transmissions are received by a network node 110 (e.g., an RU, a TRP, or the like) at a time that aligns with an internal timing of the network node 110. A network node 110 may determine the TA value to a UE 120 (e.g., directly or via one or more network nodes) by measuring a time difference between reception of uplink transmissions from the UE 120 and a subframe timing used by the network node 110 (e.g., by determining a difference between when the uplink transmissions were supposed to have been received by the network node 110, according to the subframe timing, and when the uplink transmissions were actually received). The network node 110 may transmit a TA command (TAC) to instruct the UE 120 to transmit future uplink communications earlier or later to reduce or eliminate the time difference and align timing between the UE 120 and network node 110. The TAC is used to offset timing differences between the UE 120 and the network node 110 due to different propagation delays that occur when the UE 120 is different distances from the network node 110. If TACs were not used, then uplink transmissions from different UEs 120 (e.g., located at different distances from the network node 110) may collide due to mistiming even if the uplink transmissions are scheduled for different subframes.

To illustrate, without adjusting a start time of an uplink transmission, the UE 120 may be configured to begin an uplink transmission at a scheduled point in time based at least in part on the defined time partitions as described elsewhere herein. As shown by reference number 710-1, a start of the scheduled point in time may occur at a third physical point in time based at least in part on the timing perspective of the UE 120. However, and as shown by reference number 710-2, the scheduled point in time with reference to the timing perspective of the network node 110 (e.g., an RU) may occur at a fourth point in physical time that occurs before the third point in physical time as shown by the reference number 710-1. Accordingly, the network node 110 may instruct the UE 120 (e.g., directly or via one or more network nodes) to apply a timing advance 708 to an uplink transmission to better align reception of the uplink transmission with the timing perspective of the network node 110. However, in some examples, the fourth point in time shown by the reference number 710-2 may occur at or near a same physical point in time as the third point in time shown by the reference number 710-1 such that uplink transmissions from the UE 120 to the network node 110 incur the propagation delay 706. In such a scenario, the network node 110 may instruct the UE 120 to apply a timing advance with a time duration corresponding to the propagation delay 706.

As shown by the example 700, the UE 120 may adjust a start time of an uplink transmission 712-1 based at least in part on the timing advance 708 and the start of the scheduled point in time (e.g., at the third physical point in time shown by the reference number 710-1). Based at least in part on propagation delay, the network node 110 may receive an uplink transmission 712-2 (corresponding to the uplink transmission 712-1 transmitted by the UE 120) at the fourth point in physical time shown by the reference number 710-2.

In some examples, a timing advance value may be based at least in part on twice an estimated propagation delay (e.g., the propagation delay 706) and/or may be based at least in part on a round trip time (RTT). A network node 110 (e.g., a DU or a CU) may estimate the propagation delay and/or select a timing advance value based at least in part on communications with the UE 120. As one example, the network node 110 may estimate the propagation delay based at least in part on a network access request message from the UE 120. Additionally, or alternatively, the network node 110 may estimate and/or select the timing advance value from a set of fixed timing advance values.

In some examples, a telecommunication system and/or telecommunication standards may define a guard period 714 (e.g., a time duration) between transmissions to provide a device with sufficient time for switching between different transmission and/or reception modes, for transient settling, to provide a margin for timing misalignment between devices, and/or for propagation delays. In some examples, a guard period is a period during which no transmissions or receptions are scheduled and/or allowed to occur. A guard period may provide a device with sufficient time to reconfigure hardware and/or allow the hardware to settle within a threshold value to enable a subsequent transmission. The guard period 714 may sometimes be referred to as a gap, a switching guard period, or a guard interval.

In some examples, a network node 110 (e.g., a DU or a CU) may select a starting transmission time and/or a transmission time duration based at least in part on a receiving device and/or the guard period. For example, the network node 110 may select an amount of content (e.g., data and/or control information) to transmit in the downlink transmission 704-1 based at least in part on beginning the transmission at the first point in time shown by the reference number 702-1 and/or the UE 120 completing reception of the downlink transmission 704-2 prior to a starting point of the guard period 714. Alternatively, or additionally, the UE 120 may select an amount of content (e.g., data and/or control information) to transmit in the uplink transmission 712-1 based at least in part on the timing advance 708, the third point in time shown by the reference number 710-1, and/or refraining from beginning the uplink transmission 712-1 until the guard period 714 has ended.

In some aspects, a UE 120 may be configured with one or more timing advance groups (TAGs). “TAG” may refer to a group of cells which share the same uplink timing. When a UE 120 is in communication with multiple TRPs (e.g., the TRPs 505 and/or TRPs 605), the multiple TRPs may be associated with a common TAG for purposes of timing advance control procedures, while, in some other aspects, the TRPs may be associated with different TAGs for purposes of timing advance control procedures. More particularly, if the TRPs are near to one another, they may experience similar propagation delays with respect to communications with the UE 120. Thus, two or more TRPs may form part of a single TAG, meaning that the TRPs share the same uplink transmission timing (e.g., they are subject to the same timing advance 708). However, TRPs that are geographically separated or otherwise relatively far from one another may experience different propagation delays with respect to communications with the UE 120, and thus two or more TRPs may be associated with different uplink transmission timings and thus different TAGs (e.g., they may be subject to different timing advances 708). In cases in which a UE 120 is in communication with two or more TRPs, with each TRP being associated with a different timing advance parameter, the UE 120 may thus receive multiple TACs in order to separately establish a timing advance 708 for each TAG (e.g., for each TRP).

In some cases, a timing advance 708 associated with the UE 120 may need to be updated or otherwise adjusted. For example, if the UE 120 moves from one location (e.g., one geographic location) to another location (e.g., a different geographic location), the UE 120 may be either further away from, or closer to, the network node 110, resulting in a different propagation delay 706 associated with communications between the network node 110 and the UE 120. Accordingly, the UE 120 may need to adjust the timing advance 708 such that communications between the network node 110 and the UE 120 are synchronized in the manner described above (e.g., such that the uplink transmission 712-1 arrives at the network node 110 at the fourth point in time shown by the reference number 710-2, as described).

In some examples, the UE 120 may autonomously adjust the timing advance 708 when moving to a new location (e.g., a new geographic location) based at least in part on a measured downlink reception timing difference between a new location of the UE 120 and a previous location of the UE 120 (e.g., a location in which a previous timing advance 708 was determined and/or a location where a UE 120 received one or more TACs establishing a previous timing advance 708). For example, the UE 120 may autonomously adjust the timing advance 708 such that a new timing advance (sometimes referred to as TA_{new}) is equal to T_{RX_new}−(N_{TA_new}+N_{TA_offset})×T_{C}, where T_{RX_new} corresponds to the downlink frame reception timing for the new location; T_{C} corresponds to the NR physical layer time unit (which is equal to 1/(480,000×4096) seconds, or 0.509 nanoseconds); N_{TA_offset} corresponds to a semi-static timing advance offset value, which may be signaled by a network node 110 via a system information block (SIB) (e.g., SIB1) or via dedicated signaling to the UE 120, or which otherwise may be equal to a default value that may be defined according to a wireless communication specification, such as Technical Specification (TS) 38.133 promulgated by the 3GPP; and N_{TA_new} corresponds to a UE 120 autonomously adjusted time alignment amount for the new location. In some cases, the UE 120 autonomously adjusted time alignment amount for the new location (e.g., N_{TA_new}) may be equal to N_{TA_old}−2×(T_{RX_old}−T_{RX_new}), where T_{RX_ old} corresponds to the downlink frame reception timing for the old location of the UE 120, and N_{TA_old} corresponds to the time alignment amount for the old location, which, in some cases, may have been signaled by a network node 110 via a TAC.

The autonomous timing advance adjustment procedure described above is predicated on certain assumptions, such as that the serving cell is associated only with a single timing advance 708 and/or that a downlink propagation delay 706 is the same as or similar to an uplink propagation delay. However, when a UE 120 is in communication with multiple network nodes 110, such as when the UE 120 is in communication with the multiple TRPs 505, 605 described in connection with FIGS. 5 and 6, the UE 120 may use multiple timing advances, one for each TRP (e.g., the UE 120 may be configured with multiple TAGs, as described). For example, if a UE 120 is operating in a multi-DCI, multi-TRP cell (e.g., a cell in which the UE 120 is being served by two or more TRPs and/or in which the UE 120 receives multiple scheduling DCI communications, one for each TRP), the UE 120 may be configured with a first timing advance associated with a first TRP (e.g., associated with a first CORESETPoolIndex, such as CORESETPoolIndex 0, and/or with a first TAG), and the UE 120 may be configured with a second timing advance associated with a second TRP (e.g., associated with a second CORESETPoolIndex, such as CORESETPoolIndex 1, and/or with a second TAG). In such cases, the autonomous timing advance adjustment procedure described above may be inadequate to update the multiple timing advance parameters, because the underlying assumptions associated with the procedure (e.g., that the serving cell is associated only with a single timing advance 708 and/or that a downlink propagation delay 706 is the same as or similar to an uplink propagation delay) may not apply to the multi-DCI, multi-TRP cell scenario.

For example, in a multi-DCI, multi-TRP cell, a first subset of reference signals (e.g., a first subset of synchronization signal blocks (SSBs)) associated with the multi-DCI, multi-TRP cell used to perform measurements associated with the autonomous timing advance adjustment procedure may be associated with the first TRP, and a second subset of reference signals (e.g., a second subset of SSBs) associated with the multi-DCI, multi-TRP cell used to perform measurements associated with the autonomous timing advance adjustment procedure may be associated with the second TRP. In such cases, when performing the autonomous timing advance adjustment procedure described above, the UE 120 may synchronize to a strongest and/or earliest received SSB, which will be from either the first subset of SSBs or the second subset of SSBs. That is, the UE 120 will use the strongest and/or earliest received SSB to determine the downlink frame reception times for the autonomous timing advance adjustment for both TRPs (e.g., both for the TRP associated with the SSB and the TRP that is not associated with the SSB). Thus, in cases in which the downlink reception timing for the first TRP is significantly different from the second TRP, the timing advance for at least one of the TRPs will be incorrect for at least one TRP following the autonomous timing advance adjustment procedure. This may result in unsynchronized communications, leading to high error rates and thus high latency; low throughput; high computing, power, or network resource consumption associated with error correction procedures; inefficient usage of network resources; and, in some cases, radio link failure.

Some techniques and apparatuses described herein enable a per-TRP autonomous timing advance adjustment procedure. In some aspects, after changing locations (e.g., after moving from a first geographic location to a second geographic location) or when communications otherwise become unsynchronized, a UE 120 may determine a downlink reception timing for each TRP of multiple TRPs in a multi-DCI, multi-TRP cell. The UE 120 may do so by measuring a first reference signal associated with a first TRP and/or a first TRP identifier for purposes of determining a downlink reception timing associated with the first TRP, and by measuring a second reference signal associated with a second TRP and/or a second TRP identifier for purposes of determining a downlink reception timing associated with the second TRP. The UE 120 may adjust a timing advance associated with each TRP based at least in part on a corresponding downlink reception timing determined by the UE 120 in the new location. Thus, following a change in location by the UE 120, multiple timing advances associated with multiple TRPs may be autonomously updated based at least in part on corresponding downlink reception timings associated with each TRP, resulting in synchronized communications between the UE 120 and the TRPs. As a result, the UE 120 and the TRPs may experience low error rates and reduced latency; increased throughput; low computing, power, or network resource consumption associated with error correction procedures; more efficient usage of network resources; and overall more reliable communication channels.

As indicated above, FIG. 7 is provided as an example. Other examples may differ from what is described with regard to FIG. 7.

FIG. 8 is a diagram of an example 800 associated with autonomous timing advance adjustment for multiple transmission reception points, in accordance with the present disclosure. As shown in FIG. 8, a first network node 110-1 (e.g., a first TRP, such as one of TRPs 505 and/or 605) and a second network node 110-2 (e.g., a second TRP, such as one of TRPs 505 and/or 605) may communicate with a UE 120. In some aspects, the first network node 110-1, the second network node 110-2, and the UE 120 may be part of a wireless network (e.g., wireless network 100). The UE 120, the first network node 110-1, and the second network node 110-2 may have established a wireless connection prior to operations shown in FIG. 8. For example, the first network node 110-1 and the second network node 110-2 may be TRPs associated with a multi-DCI, multi-TRP cell, and the UE 120 may have established a connection to each TRP of the multi-DCI, multi-TRP cell.

As shown by reference number 805, the first network node 110-1 and/or the second network node 110-2 may transmit, and the UE 120 may receive, configuration information. In some aspects, the UE 120 may receive the configuration information via one or more of RRC signaling, one or more MAC control elements (MAC-CEs), and/or DCI, among other examples. In some aspects, the configuration information may include an indication of one or more configuration parameters (e.g., already known to the UE 120 and/or previously indicated by the first network node 110-1, the second network node 110-2, or other network device) for selection by the UE 120, and/or explicit configuration information for the UE 120 to use to configure the UE 120, among other examples.

In some aspects, the first network node 110-1 may be a first TRP associated with a multi-DCI, multi-TRP cell, and the second network node 110-2 may be a second TRP associated with the multi-DCI, multi-TRP cell, as described. In such aspects, the UE 120 may be configured with multiple CORESETs and/or multiple CORESET pool indexes, as described above in connection with FIG. 6. More particularly, the UE 120 may be configured with a first CORESET pool index (e.g., CORESET pool index 0) associated with the first network node 110-1, and/or the UE 120 may be configured with a second CORESET pool index (e.g., CORESET pool index 1) associated with the second network node 110-2. In some aspects, the UE 120 may be configured with multiple TAGs. For example, the UE 120 may be configured with a first TAG associated with the first network node 110-1 and/or the first CORESET pool index, and/or the UE 120 may be configured with a second TAG associated with the second network node 110-2 and/or the second CORESET pool index.

Additionally, or alternatively, the UE 120 may be configured with multiple reference signal configurations. For example, the UE 120 may be configured with a first reference signal configuration associated with the first network node 110-1, and the UE 120 may be configured with a second reference signal configuration associated with the second network node 110-2. The multiple reference signal configurations may indicate time and/or frequency resources for receiving one or more reference signals associated with the first network node 110-1 and/or the second network node 110-2. For example, the multiple reference signal configurations may configure time and/or frequency resources for receiving one or more SSBs, positioning reference signals (PRBs), channel state information (CSI) reference signals (CSI-RSs), or the like, from each of the first network node 110-1 and the second network node 110-2. In some aspects, the one or more SSBs, PRBs, or CSI-RSs may be used to perform measurements associated with a multi-TRP autonomous timing advance adjustment procedure, as is described in more detail below in connection with reference number 835.

The UE 120 may configure itself based at least in part on the configuration information. In some aspects, the UE 120 may be configured to perform one or more operations described herein based at least in part on the configuration information.

As shown by reference numbers 810 and 815, the first network node 110-1 and/or the second network node 110-2 may transmit, and the UE 120 may receive, one or more TACs, such as the TAC described in connection with FIG. 7. In that regard, the one or more TACs may instruct the UE 120 to transmit future uplink communications earlier or later to reduce or eliminate the time difference and align timing between the UE 120 and respective network nodes 110-1, 110-2. In some aspects, the UE 120 may receive two TACs, one TAC associated with the first network node 110-1, the first CORESET pool index, and/or the first TAG, and another TAC associated with the second network node 110-2, the second CORESET pool index, and/or the second TAG.

As shown by reference number 820, the UE 120 may synchronize timing associated with the first network node 110-1 and/or the second network node 110-2. For example, based at least in part on the TACs described in connection with reference numbers 810 and 815, the UE 120 may determine and/or apply a first timing advance (e.g., a first timing advance 708) associated with uplink communications transmitted to the first network node 110-1, and/or may determine and/or apply a second timing advance (e.g., a second timing advance 708) associated with uplink communications transmitted to the second network node 110-2, as described above in connection with FIG. 7.

In some aspects, the UE 120 may need to later adjust and/or update the timing advance associated with the first network node 110-1 and/or the timing advance associated with the second network node 110-2 based at least in part on the timing between the UE 120 and the first network node 110-1 and/or the timing between the UE 120 and the second network node 110-2 becoming unsynchronized. For example, if the UE 120 changes locations (e.g., if the UE changes geographic locations), the UE 120 may become farther away or closer to the first network node 110 and/or the second network node 110-2, resulting in different prorogation delays between the UE 120 and the first network node 110 and/or the second network node 110-2 than the propagation delays that existed when the UE 120 received the TACs from the first network node 110-1 and the second network node 110-2. Thus, the UE 120 may need to adjust the timing advance(s) associated with one or both network nodes 110-1, 110-2 in order to synchronize transmissions between the UE 120 and the network nodes 110-1, 110-2.

In that regard, and as shown by reference numbers 825 and 830, the UE 120 may receive, and the first network node 110-1 and the second network node 110-2 may transmit, one or more reference signals. For example, the UE 120 may receive one or more SSBs, PRBs, CSI-RSs, or the like from each of the first network node 110-1 and the second network node 110-2, in accordance with the configuration information described in connection with reference number 805. In some aspects, the UE 120 may receive multiple reference signals from one or both of the network nodes 110-1, 110-2. For example, the UE 120 may receive, and the first network node 110-1 may transmit, a first set of reference signals, and/or the UE 120 may receive, and the second network node 110-2 may transmit, a second set of reference signals. In some aspects, when the UE 120 receives multiple reference signals from a network node 110-1, 110-2, the UE 120 may perform a measurement (e.g., determine a downlink timing associated with a network node 110-1, 110-2, as is described in more detail below) using a strongest reference signal, of the set of reference signals, and/or using an earliest arriving reference signal, of the set of reference signals. More particularly, the UE 120 may determine a downlink timing associated with the first network node 110-1 using a strongest reference signal, of the first set of reference signals, or an earliest arriving path of a reference signal, of the first set of reference signals, and/or the UE 120 may determine a downlink timing associated with the second network node 110-2 using a strongest reference signal, of the second set of reference signals, or an earliest arriving path reference signal, of the second set of reference signals.

In some aspects, each reference signal may be associated with an identifier (sometimes referred to as a TRP identifier) indicating a corresponding network node 110-1, 110-2 from which the reference signal originated and/or indicating a corresponding network node 110-1, 110-2 for which a timing advance parameter should be autonomously adjusted based on a measurement of the reference signal. More particularly, one or more reference signals received from the first network node 110-1, as shown by reference number 825, may be associated with a first identifier indicating that the reference signals are associated with the first network node 110-1, and/or one or more reference signals received from the second network node 110-2, as shown by reference number 830, may be associated with a second identifier indicating that the reference signals are associated with the second network node 110-2. In some aspects, the first identifier (e.g., a first TRP identifier) and/or the second identifier (e.g., a second TRP identifier) may be a CORESET pool index, a physical channel identity (PCI), or a sounding reference signal (SRS) set identifier associated with the corresponding network node 110-1, 110-2. In some other aspects, the first identifier and/or the second identifier may be an identifier uniquely assigned and/or indicated for purposes of the autonomous timing advance adjustment procedure (sometimes referred to as a timing advance adjustment identifier). For example, a timing advance adjustment identifier may be used to indicate a specific TRP associated with one or more reference signals (sometimes referred to as a TRP-specific identifier), a specific panel associated with one or more reference signals (sometimes referred to as a panel identifier), a specific beam group associated with one or more reference signals (sometimes referred to as a beam group indicator), or the like.

In some aspects, the UE 120 may receive, and one or more of the first network node 110-1 or the second network node 110-2 may transmit, an indication associating one or more reference signals with the first network node 110-1 and one or more other reference signals with the second network node 110-2. Put another way, the UE 120 may receive, and one or more of the first network node 110-1 or the second network node 110-2 may transmit, an indication associating the first set of reference signals with the first identifier (e.g., a CORESET pool index, a PCI, an SRS set identifier, a timing advance adjustment identifier, a TRP-specific identifier, a panel identifier, a beam group indicator, or the like associated with the first network node 110-1) and associating the second set of reference signals with the second identifier (e.g., a CORESET pool index, a PCI, an SRS set identifier, a timing advance adjustment identifier, a TRP-specific identifier, a panel identifier, a beam group indicator, or the like associated with the second network node 110-2). For example, the UE 120 may receive the indication associating the first set of reference signals with the first identifier and/or the first network node 110-1 and associating the second set of reference signals with the second identifier and/or the second network node 110-2 via one of an RRC communication, a MAC-CE communication, or a DCI communication.

In some aspects, the indication associating first set of reference signals with the first identifier and/or the first network node 110-1 and associating the second set of reference signals with the second identifier and/or the second network node 110-2 may be a bitmap, such as a bitmap mapping the one or more reference signals to the first identifier and mapping the one or more other reference signals to the second identifier. Additionally, or alternatively, the indication associating the first set of reference signals with the first identifier and/or the first network node 110-1 and associating the second set of reference signals with the second identifier and/or the second network node 110-2 may be included in, or otherwise associated with, configurations of the reference signals, as described above in connection with reference number 805. For example, a first reference signal configuration associated with the first set of reference signals may include an indication associating the first set of reference signals with the first identifier and/or the first network node 110-1, and a second reference signal configuration associated with the second set of reference signals may include an indication associating the second set of reference signals with the second identifier and/or the second network node 110-2.

In some aspects, one or both of the network nodes 110-1, 110-2 may configure the UE 120 (e.g., via the configuration information described in connection with reference number 805) with groups of reference signals associated with each network node 110-1, 110-2. That is, the UE 120 may receive a first reference signal group configuration associating a first group of reference signals with the first identifier and/or the first network node 110-1, and/or the UE 120 may receive a second reference signal group configuration associating a second group of reference signals with the second identifier and/or the second network node 110-2. For example, the first group configuration may indicate that a first subset of SSBs (e.g., SSBs 0-9) are associated with the first network node 110-1, and the second group configuration may indicate that a second subset of SSBs (e.g., SSBs 10-19) are associated with the first network node 110-1. Thus, when the UE 120 receives one or more SSBs associated with indexes 0-9, the UE 120 may use the one or more SSBs for purposes of adjusting a timing advance associated with the first network node 110-1, and when the UE 120 receives one or more SSBs associated with indexes 10-19, the UE 120 may use the one or more SSBs for purposes of adjusting a timing advance associated with the second network node 110-2.

In some aspects, the UE 120 may perform one or more network-node-specific measurements using the reference signals described in connection with reference numbers 825 and 830. For example, the UE 120 may measure the one or more reference signals to determine a downlink reception timing associated with each network node 110-1, 110-2 in the new location of the UE 120. Put another way, the UE 120 may measure a downlink reception time (e.g., a time from transmission, by the first network 110-1, of a reference signal to reception, by the UE 120, of the reference signal, which may be associated with a propagation delay 706) using one or more reference signals transmitted by the first network node 110-1 (e.g., by using a strongest reference signal and/or an earliest arriving reference signal associated with the first network node 110-1), and the UE 120 may measure another downlink reception time using one or more reference signals transmitted by the second network node 110-2 (e.g., by using a strongest reference signal and/or an earliest arriving reference signal associated with the second network node 110-2).

As shown by reference number 835, the UE 120 may perform an autonomous (e.g., without requiring a TAC from a network node 110-1, 110-2) timing advance adjustment procedure associated with the first network node 110-1 and the second network node 110-2, sometimes referred to herein as a multi-network-node autonomous timing advance adjustment procedure or a multi-TRP autonomous timing advance adjustment procedure. More particularly, the UE 120 may perform an autonomous timing advance adjustment procedure by autonomously adjusting a first timing advance associated with the first network node 110 based at least in part on a measurement associated with one or more reference signals received from the first network node 110-1, and by autonomously adjusting a second timing advance associated with the second network node 110-2 based at least in part on a measurement associated with one or more reference signals received from the second network node 110-2.

In some aspects, the UE 120 may autonomously adjust each timing advance per network node 110-1, 110-2, based at least in part on at least one of: a new (e.g., associated with a new, or current, location of the UE 120 after changing locations) downlink reception timing associated with a corresponding network node 110-1, 110-2 (e.g., T_{RX_new}); a physical layer time constant (e.g., T_{C}); a timing advance offset value (e.g., N_{TA_offset}), which may have been previously signaled to the UE 120 via a corresponding RRC signaling or a TAC, as described in connection with reference numbers 810 and 815; a new time alignment amount associated with the corresponding network node 110-1, 110-2 (e.g., N_{TA_new}), an old (e.g., associated with an old, or previous, location of the UE 120 prior to moving locations) time alignment amount associated with the corresponding network node 110-1, 110-2 (e.g., N_{TA_old}), which may have been previously signaled to the UE 120 via a corresponding TAC, as described in connection with reference numbers 810 and 815; or an old downlink reception timing associated with the corresponding network node 110-1, 110-2 (e.g., T_{RX_old}). For example, the UE 120 may adjust each timing advance (e.g., the timing advance associated with the first network node 110-1 and the timing advance associated with the second network node 110-2) according to the equation TA_{new}=T_{RX_new}−(N_{TA_new}+N_{TA_offset})×T_{C}, where T_{RX_new} corresponds to the downlink frame reception timing for the new location for the corresponding network node 110-1, 110-2 (e.g., determined using a reference signal associated with the corresponding network node 110-1, 110-2); T_{C} corresponds to the NR physical layer time unit (which is equal to 1 /(480,000×4096) seconds, or 0.509 nanoseconds); N_{TA_offset} corresponds to a semi-static timing advance offset value, which may be signaled by a network node 110-1, 110-2 via a SIB (e.g., SIB1) or via dedicated signaling to the UE 120, or which otherwise may be equal to a default value that may be defined according to a wireless communication specification, such as TS 38.133 promulgated by the 3GPP; and N_{TA_new} corresponds to a UE 120 autonomously adjusted time alignment amount for the new location. In some aspects, the UE 120 autonomously adjusted time alignment amount for the new location (e.g., N_{TA_new}) may be equal to N_{TA_old}−2×(T_{RX_old}−T_{RX_new}), where T_{RX_old} corresponds to the downlink frame reception timing for the old location of the UE 120, and N_{TA_old} corresponds to the time alignment amount for the old location, which may have been signaled by a network node 110-1, 110-2 via a corresponding TAC described in connection with reference numbers 810 and 815.

In some aspects, the autonomous timing advance adjustment procedure described above may be summarized as follows: For a serving cell with two CORESET pool indexes and two timing advances, if the received downlink timing associated with a CORESET pool index changes and is not compensated or is only partly compensated by the uplink timing adjustment without timing advance command for the same CORESET pool index as described in TS 38.133 promulgated by the 3GPP, the UE changes NTA associated with the same CORESET pool index accordingly.

As shown by reference numbers 840 and 845, the UE 120 may communicate with the first network node 110-1 and/or the second network node 1110-2 based at least in part on the autonomous timing advance adjustment procedure. More particularly, as shown by reference number 840, the UE 120 may transmit, and the first network node 110-1 may receive, a first communication, with a timing of the first communication being based at least in part on the multi-TRP autonomous timing advance adjustment procedure performed by the UE 120 (e.g., with a timing of the first communication being associated with a first autonomously adjusted timing advance parameter, as described in connection with reference number 835). Additionally, or alternatively, as shown by reference number 845, the UE 120 may transmit, and the second network node 110-2 may receive, a second communication, with a timing of the second communication similarly being based at least in part on the multi-TRP autonomous timing advance adjustment procedure performed by the UE 120 (e.g., with a timing of the second communication being associated with a second autonomously adjusted timing advance parameter, as described in connection with reference number 835).

Based at least in part on the UE 120 performing the multi-TRP autonomous timing advance adjustment procedure described above, the UE 120 and/or the network node 110-1, 110-2 may conserve computing, power, network, and/or communication resources that may have otherwise been consumed by using traditional autonomous timing advance adjustment procedures. For example, based at least in part on the UE 120 performing a multi-TRP autonomous timing advance adjustment procedure, the UE 120 may more accurately synchronize timing for multiple network nodes 110-1, 110-2, resulting in the UE 120 and the network nodes 110-1, 110-2 communicating with improved synchronization and thus a reduced error rate, which may conserve computing, power, network, and/or communication resources that may have otherwise been consumed to detect and/or correct communication errors and/or reestablishing a connection following radio link failure, or the like.

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., UE 120) performs operations associated with autonomous timing advance adjustment for multiple TRPs.

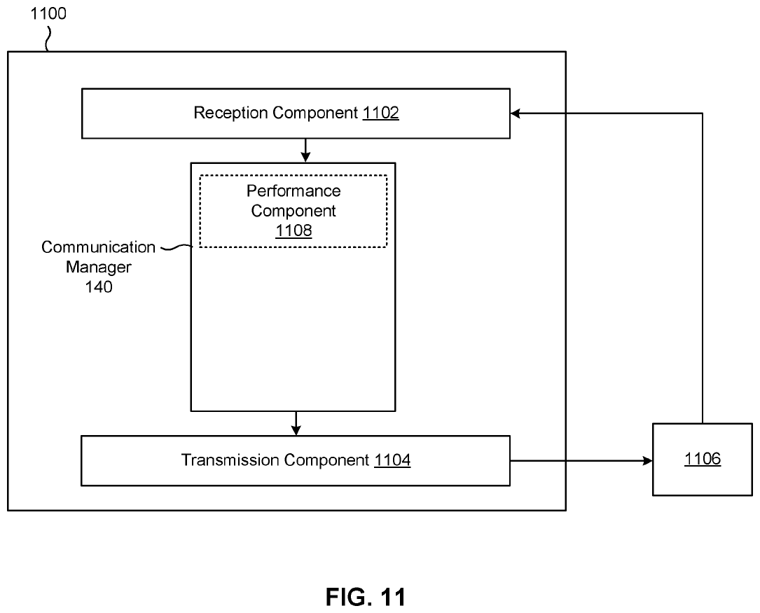

As shown in FIG. 9, in some aspects, process 900 may include receiving, from a first TRP, a first reference signal (block 910). For example, the UE (e.g., using communication manager 140 and/or reception component 1102, depicted in FIG. 11) may receive, from a first TRP, a first reference signal, as described above.

As further shown in FIG. 9, in some aspects, process 900 may include receiving, from a second TRP, a second reference signal (block 920). For example, the UE (e.g., using communication manager 140 and/or reception component 1102, depicted in FIG. 11) may receive, from a second TRP, a second reference signal, as described above.

As further shown in FIG. 9, in some aspects, process 900 may include performing an autonomous timing advance adjustment procedure by autonomously adjusting a first timing advance parameter associated with the first TRP based at least in part on a measurement associated with the first reference signal and autonomously adjusting a second timing advance parameter associated with the second TRP based at least in part on a measurement associated with the second reference signal (block 930). For example, the UE (e.g., using communication manager 140 and/or performance component 1108, depicted in FIG. 11) may perform an autonomous timing advance adjustment procedure by autonomously adjusting a first timing advance parameter associated with the first TRP based at least in part on a measurement associated with the first reference signal and autonomously adjusting a second timing advance parameter associated with the second TRP based at least in part on a measurement associated with the second reference signal, as described above.

Process 900 may include additional aspects, such as any single aspect or any combination of aspects described below and/or in connection with one or more other processes described elsewhere herein.

In a first aspect, the measurement associated with the first reference signal is associated with a first downlink reception timing associated with the first TRP, and the measurement associated with the second reference signal is associated with a second downlink reception timing associated with the second TRP.

In a second aspect, alone or in combination with the first aspect, for each of the first TRP and the second TRP, autonomously adjusting a corresponding timing advance parameter is based at least in part on at least one of: a new downlink reception timing associated with a corresponding TRP, a physical layer time constant, a timing advance offset value, a new time alignment amount associated with the corresponding TRP, an old time alignment amount associated with the corresponding TRP, or an old downlink reception timing associated with the corresponding TRP.

In a third aspect, alone or in combination with one or more of the first and second aspects, process 900 includes receiving, from the first TRP, a first set of reference signals, wherein the first reference signal is one of a strongest reference signal, of the first set of reference signals, or an earliest arriving reference signal, of the first set of reference signals, and receiving, from the second TRP, a second set of reference signals, wherein the second reference signal is one of a strongest reference signal, of the second set of reference signals, or an earliest arriving reference signal, of the second set of reference signals.

In a fourth aspect, alone or in combination with one or more of the first through third aspects, at least one of the first reference signal or the second reference signal is one of a synchronization signal block, a channel state information reference signal, or a positioning reference signal.

In a fifth aspect, alone or in combination with one or more of the first through fourth aspects, the first reference signal is associated with a first TRP identifier associated with the first TRP, and the second reference signal is associated with a second TRP identifier associated with the second TRP.

In a sixth aspect, alone or in combination with one or more of the first through fifth aspects, at least one of the first TRP identifier or the second TRP identifier is associated with one of a control resource set pool index, a physical channel identity, or a sounding reference signal set identifier.

In a seventh aspect, alone or in combination with one or more of the first through sixth aspects, process 900 includes receiving an indication associating the first reference signal with the first TRP identifier and associating the second reference signal with the second TRP identifier.

In an eighth aspect, alone or in combination with one or more of the first through seventh aspects, the indication associating the first reference signal with the first TRP identifier and associating the second reference signal with the second TRP identifier is received via one of a radio resource control communication, a MAC-CE communication, or a downlink control information message.

In a ninth aspect, alone or in combination with one or more of the first through eighth aspects, the indication associating the first reference signal with the first TRP identifier and associating the second reference signal with the second TRP identifier is associated with a bitmap mapping the first reference signal to the first TRP identifier and mapping the second reference signal to the second TRP identifier.

In a tenth aspect, alone or in combination with one or more of the first through ninth aspects, the indication associating the first reference signal with the first TRP identifier is associated with a first reference signal configuration associated with the first reference signal, and the indication associating the second reference signal with the second TRP identifier is associated with a second reference signal configuration associated with the second reference signal.

In an eleventh aspect, alone or in combination with one or more of the first through tenth aspects, process 900 includes receiving a first reference signal group configuration associated with the first reference signal, wherein the indication associating the first reference signal with the first TRP identifier is associated with the first reference signal group configuration, and receiving a second reference signal group configuration associated with the second reference signal, wherein the indication associating the second reference signal with the second TRP identifier is associated with the second reference signal group configuration.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 110) performs operations associated with autonomous timing advance adjustment for multiple TRPs.

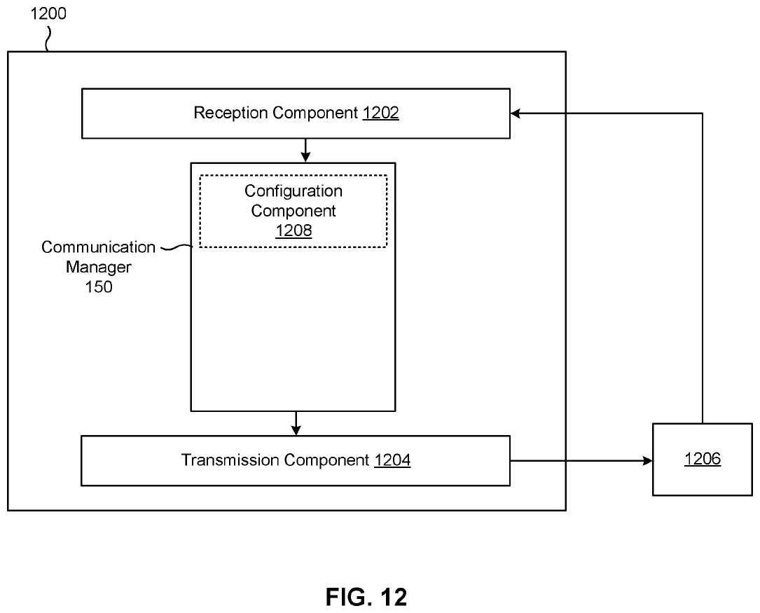

As shown in FIG. 10, in some aspects, process 1000 may include transmitting, to a UE (e.g., UE 120), a reference signal configuration associated with a TRP (block 1010). For example, the network node (e.g., using communication manager 150 and/or transmission component 1204, depicted in FIG. 12) may transmit, to a UE, a reference signal configuration associated with a TRP, as described above.

As further shown in FIG. 10, in some aspects, process 1000 may include transmitting, to the UE, a reference signal based at least in part on the reference signal configuration (block 1020). For example, the network node (e.g., using communication manager 150 and/or transmission component 1204, depicted in FIG. 12) may transmit, to the UE, a reference signal based at least in part on the reference signal configuration, as described above.

As further shown in FIG. 10, in some aspects, process 1000 may include receiving, from the UE, a communication, wherein a timing of the communication is based at least in part on a multi-TRP autonomous timing advance adjustment procedure performed by the UE (block 1030). For example, the network node (e.g., using communication manager 150 and/or reception component 1202, depicted in FIG. 12) may receive, from the UE, a communication, wherein a timing of the communication is based at least in part on a multi-TRP autonomous timing advance adjustment procedure performed by the UE, as described above.

Process 1000 may include additional aspects, such as any single aspect or any combination of aspects described below and/or in connection with one or more other processes described elsewhere herein.

In a first aspect, the multi-TRP autonomous timing advance adjustment procedure is associated with a downlink reception timing associated with the TRP and with another downlink reception timing associated with another TRP.

In a second aspect, alone or in combination with the first aspect, the multi-TRP autonomous timing advance adjustment procedure is based at least in part on at least one of a new downlink reception timing associated with the TRP, a physical layer time constant, a timing advance offset value, a new time alignment amount associated with the TRP, an old time alignment amount associated with the TRP, or an old downlink reception timing associated with the TRP.

In a third aspect, alone or in combination with one or more of the first and second aspects, process 1000 includes transmitting, to the UE, a set of reference signals, wherein the UE uses, for the multi-TRP autonomous timing advance adjustment procedure, one of a strongest reference signal, of the set of reference signals, or an earliest arriving reference signal, of the set of reference signals.

In a fourth aspect, alone or in combination with one or more of the first through third aspects, the reference signal is one of a synchronization signal block, a channel state information reference signal, or a positioning reference signal.

In a fifth aspect, alone or in combination with one or more of the first through fourth aspects, the reference signal is associated with a TRP identifier associated with the TRP.

In a sixth aspect, alone or in combination with one or more of the first through fifth aspects, the TRP identifier is associated with one of a control resource set pool index, a physical channel identity, or a sounding reference signal set identifier.

In a seventh aspect, alone or in combination with one or more of the first through sixth aspects, process 1000 includes transmitting, to the UE, an indication associating the reference signal with the TRP identifier.

In an eighth aspect, alone or in combination with one or more of the first through seventh aspects, the indication associating the reference signal with the TRP identifier is transmitted via one of a radio resource control communication, a MAC-CE communication, or a downlink control information message.

In a ninth aspect, alone or in combination with one or more of the first through eighth aspects, the indication associating the reference signal with the TRP identifier is associated with a bitmap mapping the reference signal to the TRP.

In a tenth aspect, alone or in combination with one or more of the first through ninth aspects, the indication associating the reference signal with the TRP identifier is transmitted in a communication including the reference signal configuration.

In an eleventh aspect, alone or in combination with one or more of the first through tenth aspects, process 1000 includes transmitting, to the UE, a reference signal group configuration associated with the reference signal, wherein the indication associating the reference signal with the TRP identifier is associated with the reference signal group configuration.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE (e.g., UE 120), or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE 120, a network node 110, or another wireless communication device) using the reception component 1102 and the transmission component 1104. As further shown, the apparatus 1100 may include the communication manager 140. The communication manager 140 may include a performance component 1108, among other examples.

In some aspects, the apparatus 1100 may be configured to perform one or more operations described herein in connection with FIG. 8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE 120 described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE 120 described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE 120 described in connection with FIG. 2. In some aspects, the transmission component 1104 may be co-located with the reception component 1102 in a transceiver.

The reception component 1102 may receive, from a first TRP, a first reference signal. The reception component 1102 may receive, from a second TRP, a second reference signal. The performance component 1108 may perform an autonomous timing advance adjustment procedure by autonomously adjusting a first timing advance parameter associated with the first TRP based at least in part on a measurement associated with the first reference signal and autonomously adjusting a second timing advance parameter associated with the second TRP based at least in part on a measurement associated with the second reference signal.

The reception component 1102 may receive, from the first TRP, a first set of reference signals, wherein the first reference signal is one of a strongest reference signal, of the first set of reference signals, or an earliest arriving reference signal, of the first set of reference signals.

The reception component 1102 may receive, from the second TRP, a second set of reference signals, wherein the second reference signal is one of a strongest reference signal, of the second set of reference signals, or an earliest arriving reference signal, of the second set of reference signals.

The reception component 1102 may receive an indication associating the first reference signal with the first TRP identifier and associating the second reference signal with the second TRP identifier.

The reception component 1102 may receive a first reference signal group configuration associated with the first reference signal, wherein the indication associating the first reference signal with the first TRP identifier is associated with the first reference signal group configuration.

The reception component 1102 may receive a second reference signal group configuration associated with the second reference signal, wherein the indication associating the second reference signal with the second TRP identifier is associated with the second reference signal group configuration.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node (e.g., network node 110), or a network node may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE 120, a network node 110, or another wireless communication device) using the reception component 1202 and the transmission component 1204. As further shown, the apparatus 1200 may include the communication manager 150. The communication manager 150 may include a configuration component 1208, among other examples.

In some aspects, the apparatus 1200 may be configured to perform one or more operations described herein in connection with FIG. 8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node 110 described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node 110 described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the network node 110 described in connection with FIG. 2. In some aspects, the transmission component 1204 may be co-located with the reception component 1202 in a transceiver.

The transmission component 1204 and/or the configuration component 1208 may transmit, to a UE, a reference signal configuration associated with a TRP. The transmission component 1204 may transmit, to the UE, a reference signal based at least in part on the reference signal configuration. The reception component 1202 may receive, from the UE, a communication, wherein a timing of the communication is based at least in part on a multi-TRP autonomous timing advance adjustment procedure performed by the UE.

The transmission component 1204 may transmit, to the UE, a set of reference signals, wherein the UE uses, for the multi-TRP autonomous timing advance adjustment procedure, one of a strongest reference signal, of the set of reference signals, or an earliest arriving reference signal, of the set of reference signals.

The transmission component 1204 may transmit, to the UE, an indication associating the reference signal with the TRP identifier.

The transmission component 1204 and/or the configuration component 1208 may transmit, to the UE, a reference signal group configuration associated with the reference signal, wherein the indication associating the reference signal with the TRP identifier is associated with the reference signal group configuration.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a UE, comprising: receiving, from a first TRP, a first reference signal; receiving, from a second TRP, a second reference signal; and performing an autonomous timing advance adjustment procedure by autonomously adjusting a first timing advance parameter associated with the first TRP based at least in part on a measurement associated with the first reference signal and autonomously adjusting a second timing advance parameter associated with the second TRP based at least in part on a measurement associated with the second reference signal.

Aspect 2: The method of Aspect 1, wherein the measurement associated with the first reference signal is associated with a first downlink reception timing associated with the first TRP, and wherein the measurement associated with the second reference signal is associated with a second downlink reception timing associated with the second TRP.

Aspect 3: The method of any of Aspects 1-2, wherein, for each of the first TRP and the second TRP, autonomously adjusting a corresponding timing advance parameter is based at least in part on at least one of: a new downlink reception timing associated with a corresponding TRP, a physical layer time constant, a timing advance offset value, a new time alignment amount associated with the corresponding TRP, an old time alignment amount associated with the corresponding TRP, or an old downlink reception timing associated with the corresponding TRP.

Aspect 4: The method of any of Aspects 1-3, further comprising: receiving, from the first TRP, a first set of reference signals, wherein the first reference signal is one of a strongest reference signal, of the first set of reference signals, or an earliest arriving reference signal, of the first set of reference signals; and receiving, from the second TRP, a second set of reference signals, wherein the second reference signal is one of a strongest reference signal, of the second set of reference signals, or an earliest arriving reference signal, of the second set of reference signals.

Aspect 5: The method of any of Aspects 1-4, wherein at least one of the first reference signal or the second reference signal is one of a synchronization signal block, a channel state information reference signal, or a positioning reference signal.

Aspect 6: The method of any of Aspects 1-5, wherein the first reference signal is associated with a first TRP identifier associated with the first TRP, and wherein the second reference signal is associated with a second TRP identifier associated with the second TRP.

Aspect 7: The method of Aspect 6, wherein at least one of the first TRP identifier or the second TRP identifier is associated with one of a control resource set pool index, a physical channel identity, or a sounding reference signal set identifier.

Aspect 8: The method of any of Aspect 6-7, further comprising receiving an indication associating the first reference signal with the first TRP identifier and associating the second reference signal with the second TRP identifier.

Aspect 9: The method of Aspect 8, wherein the indication associating the first reference signal with the first TRP identifier and associating the second reference signal with the second TRP identifier is received via one of a radio resource control communication, a MAC-CE communication, or a downlink control information message.

Aspect 10: The method of any of Aspects 8-9, wherein the indication associating the first reference signal with the first TRP identifier and associating the second reference signal with the second TRP identifier is associated with a bitmap mapping the first reference signal to the first TRP identifier and mapping the second reference signal to the second TRP identifier.

Aspect 11: The method of any of Aspects 8-10, wherein the indication associating the first reference signal with the first TRP identifier is associated with a first reference signal configuration associated with the first reference signal, and wherein the indication associating the second reference signal with the second TRP identifier is associated with a second reference signal configuration associated with the second reference signal.

Aspect 12: The method of any of Aspects 8-11, further comprising: receiving a first reference signal group configuration associated with the first reference signal, wherein the indication associating the first reference signal with the first TRP identifier is associated with the first reference signal group configuration, and receiving a second reference signal group configuration associated with the second reference signal, wherein the indication associating the second reference signal with the second TRP identifier is associated with the second reference signal group configuration.

Aspect 13: A method of wireless communication performed by a network node, comprising: transmitting, to a UE, a reference signal configuration associated with a TRP; transmitting, to the UE, a reference signal based at least in part on the reference signal configuration; and receiving, from the UE, a communication, wherein a timing of the communication is based at least in part on a multi-TRP autonomous timing advance adjustment procedure performed by the UE.

Aspect 14: The method of Aspect 13, wherein the multi-TRP autonomous timing advance adjustment procedure is associated with a downlink reception timing associated with the TRP and with another downlink reception timing associated with another TRP.

Aspect 15: The method of any of Aspects 13-14, wherein the multi-TRP autonomous timing advance adjustment procedure is based at least in part on at least one of: a new downlink reception timing associated with the TRP, a physical layer time constant, a timing advance offset value, a new time alignment amount associated with the TRP, an old time alignment amount associated with the TRP, or an old downlink reception timing associated with the TRP.

Aspect 16: The method of any of Aspects 13-15, further comprising transmitting, to the UE, a set of reference signals, wherein the UE uses, for the multi-TRP autonomous timing advance adjustment procedure, one of a strongest reference signal, of the set of reference signals, or an earliest arriving reference signal, of the set of reference signals.

Aspect 17: The method of any of Aspects 13-16, wherein the reference signal is one of a synchronization signal block, a channel state information reference signal, or a positioning reference signal.

Aspect 18: The method of any of Aspects 13-17, wherein the reference signal is associated with a TRP identifier associated with the TRP.

Aspect 19: The method of Aspect 18, wherein the TRP identifier is associated with one of a control resource set pool index, a physical channel identity, or a sounding reference signal set identifier.

Aspect 20: The method of any of Aspects 18-19, further comprising transmitting, to the UE, an indication associating the reference signal with the TRP identifier.

Aspect 21: The method of Aspect 20, wherein the indication associating the reference signal with the TRP identifier is transmitted via one of a radio resource control communication, a MAC-CE communication, or a downlink control information message.

Aspect 22: The method of any of Aspects 20-21, wherein the indication associating the reference signal with the TRP identifier is associated with a bitmap mapping the reference signal to the TRP.

Aspect 23: The method of any of Aspects 20-22, wherein the indication associating the reference signal with the TRP identifier is transmitted in a communication including the reference signal configuration.

Aspect 24: The method of any of Aspects 20-23, further comprising transmitting, to the UE, a reference signal group configuration associated with the reference signal, wherein the indication associating the reference signal with the TRP identifier is associated with the reference signal group configuration.

Aspect 25: An apparatus for wireless communication at a device, comprising a processor; memory coupled with the processor; and instructions stored in the memory and executable by the processor to cause the apparatus to perform the method of one or more of Aspects 1-12.

Aspect 26: A device for wireless communication, comprising a memory and one or more processors coupled to the memory, the one or more processors configured to perform the method of one or more of Aspects 1-12.

Aspect 27: An apparatus for wireless communication, comprising at least one means for performing the method of one or more of Aspects 1-12.

Aspect 28: A non-transitory computer-readable medium storing code for wireless communication, the code comprising instructions executable by a processor to perform the method of one or more of Aspects 1-12.

Aspect 29: A non-transitory computer-readable medium storing a set of instructions for wireless communication, the set of instructions comprising one or more instructions that, when executed by one or more processors of a device, cause the device to perform the method of one or more of Aspects 1-12.

Aspect 30: An apparatus for wireless communication at a device, comprising a processor; memory coupled with the processor; and instructions stored in the memory and executable by the processor to cause the apparatus to perform the method of one or more of Aspects 13-24.

Aspect 31: A device for wireless communication, comprising a memory and one or more processors coupled to the memory, the one or more processors configured to perform the method of one or more of Aspects 13-24.

Aspect 32: An apparatus for wireless communication, comprising at least one means for performing the method of one or more of Aspects 13-24.

Aspect 33: A non-transitory computer-readable medium storing code for wireless communication, the code comprising instructions executable by a processor to perform the method of one or more of Aspects 13-24.

Aspect 34: A non-transitory computer-readable medium storing a set of instructions for wireless communication, the set of instructions comprising one or more instructions that, when executed by one or more processors of a device, cause the device to perform the method of one or more of Aspects 13-24.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communications at a user equipment (UE), comprising:
a processor;
memory coupled with the processor, and
instructions stored in the memory and executable by the processor to cause the apparatus to:
receive, from a first transmission reception point (TRP), a first reference signal;
receive, from a second TRP, a second reference signal; and
perform an autonomous timing advance adjustment procedure by autonomously adjusting a first timing advance parameter associated with the first TRP based at least in part on a measurement associated with the first reference signal and autonomously adjusting a second timing advance parameter associated with the second TRP based at least in part on a measurement associated with the second reference signal.

2. The apparatus of claim 1, wherein the measurement associated with the first reference signal is associated with a first downlink reception timing associated with the first TRP, and wherein the measurement associated with the second reference signal is associated with a second downlink reception timing associated with the second TRP.

3. The apparatus of claim 1, wherein, for each of the first TRP and the second TRP, autonomously adjusting a corresponding timing advance parameter is based at least in part on at least one of:
a new downlink reception timing associated with a corresponding TRP,
a physical layer time constant,
a timing advance offset value,
a new time alignment amount associated with the corresponding TRP,
an old time alignment amount associated with the corresponding TRP, or
an old downlink reception timing associated with the corresponding TRP.

4. The apparatus of claim 1, wherein the instructions further cause the apparatus to:
receive, from the first TRP, a first set of reference signals, wherein the first reference signal is one of a strongest reference signal, of the first set of reference signals, or an earliest arriving reference signal, of the first set of reference signals; and
receive, from the second TRP, a second set of reference signals, wherein the second reference signal is one of a strongest reference signal, of the second set of reference signals, or an earliest arriving reference signal, of the second set of reference signals.

5. The apparatus of claim 1, wherein at least one of the first reference signal or the second reference signal is one of a synchronization signal block, a channel state information reference signal, or a positioning reference signal.

6. The apparatus of claim 1, wherein the first reference signal is associated with a first TRP identifier associated with the first TRP, and wherein the second reference signal is associated with a second TRP identifier associated with the second TRP.

7. The apparatus of claim 6, wherein at least one of the first TRP identifier or the second TRP identifier is associated with one of a control resource set pool index, a physical channel identity, or a sounding reference signal set identifier.

8. The apparatus of claim 6, wherein the instructions further cause the apparatus to receive an indication associating the first reference signal with the first TRP identifier and associating the second reference signal with the second TRP identifier.

9. The apparatus of claim 8, wherein the indication associating the first reference signal with the first TRP identifier and associating the second reference signal with the second TRP identifier is received via one of a radio resource control communication, a medium access control (MAC) control element (MAC-CE) communication, or a downlink control information message.

10. The apparatus of claim 8, wherein the indication associating the first reference signal with the first TRP identifier and associating the second reference signal with the second TRP identifier is associated with a bitmap mapping the first reference signal to the first TRP identifier and mapping the second reference signal to the second TRP identifier.

11. The apparatus of claim 8, wherein the indication associating the first reference signal with the first TRP identifier is associated with a first reference signal configuration associated with the first reference signal, and wherein the indication associating the second reference signal with the second TRP identifier is associated with a second reference signal configuration associated with the second reference signal.

12. The apparatus of claim 8, wherein the instructions further cause the apparatus to:
receive a first reference signal group configuration associated with the first reference signal, wherein the indication associating the first reference signal with the first TRP identifier is associated with the first reference signal group configuration; and
receive a second reference signal group configuration associated with the second reference signal, wherein the indication associating the second reference signal with the second TRP identifier is associated with the second reference signal group configuration.

13. An apparatus for wireless communications at a network node, comprising:
a processor;
memory coupled with the processor; and
instructions stored in the memory and executable by the processor to cause the apparatus to:
transmit, to a user equipment (UE), a reference signal configuration associated with a transmission reception point (TRP);
transmit, to the UE, a reference signal based at least in part on the reference signal configuration; and
receive, from the UE, a communication, wherein a timing of the communication is based at least in part on a multi-TRP autonomous timing advance adjustment procedure performed by the UE.

14. The apparatus of claim 13, wherein the multi-TRP autonomous timing advance adjustment procedure is associated with a downlink reception timing associated with the TRP and with another downlink reception timing associated with another TRP.

15. The apparatus of claim 13, wherein the multi-TRP autonomous timing advance adjustment procedure is based at least in part on at least one of:
a new downlink reception timing associated with the TRP,
a physical layer time constant,
a timing advance offset value,
a new time alignment amount associated with the TRP,
an old time alignment amount associated with the TRP, or
an old downlink reception timing associated with the TRP.

16. The apparatus of claim 13, wherein the instructions further cause the apparatus to transmit, to the UE, a set of reference signals, wherein the UE uses, for the multi-TRP autonomous timing advance adjustment procedure, one of a strongest reference signal, of the set of reference signals, or an earliest arriving reference signal, of the set of reference signals.

17. The apparatus of claim 13, wherein the reference signal is one of a synchronization signal block, a channel state information reference signal, or a positioning reference signal.

18. The apparatus of claim 13, wherein the reference signal is associated with a TRP identifier associated with the TRP.

19. The apparatus of claim 18, wherein the TRP identifier is associated with one of a control resource set pool index, a physical channel identity, or a sounding reference signal set identifier.

20. The apparatus of claim 18, wherein the instructions further cause the apparatus to transmit, to the UE, an indication associating the reference signal with the TRP identifier.

21. The apparatus of claim 20, wherein the indication associating the reference signal with the TRP identifier is transmitted via one of a radio resource control communication, a medium access control (MAC) control element (MAC-CE) communication, or a downlink control information message.

22. The apparatus of claim 20, wherein the indication associating the reference signal with the TRP identifier is associated with a bitmap mapping the reference signal to the TRP.

23. The apparatus of claim 20, wherein the indication associating the reference signal with the TRP identifier is transmitted in a communication including the reference signal configuration.

24. The apparatus of claim 20, wherein the instructions further cause the apparatus to transmit, to the UE, a reference signal group configuration associated with the reference signal, wherein the indication associating the reference signal with the TRP identifier is associated with the reference signal group configuration.

25. A method of wireless communication performed by a user equipment (UE), comprising:
receiving, from a first transmission reception point (TRP), a first reference signal;
receiving, from a second TRP, a second reference signal; and
performing an autonomous timing advance adjustment procedure by autonomously adjusting a first timing advance parameter associated with the first TRP based at least in part on a measurement associated with the first reference signal and autonomously adjusting a second timing advance parameter associated with the second TRP based at least in part on a measurement associated with the second reference signal.

26. The method of claim 25, wherein the measurement associated with the first reference signal is associated with a first downlink reception timing associated with the first TRP, and wherein the measurement associated with the second reference signal is associated with a second downlink reception timing associated with the second TRP.

27. The method of claim 25, wherein, for each of the first TRP and the second TRP, autonomously adjusting a corresponding timing advance parameter is based at least in part on at least one of:
a new downlink reception timing associated with a corresponding TRP,
a physical layer time constant,
a timing advance offset value,
a new time alignment amount associated with the corresponding TRP,
an old time alignment amount associated with the corresponding TRP, or
an old downlink reception timing associated with the corresponding TRP.

28. The method of claim 25, further comprising:
receiving, from the first TRP, a first set of reference signals, wherein the first reference signal is one of a strongest reference signal, of the first set of reference signals, or an earliest arriving reference signal, of the first set of reference signals; and
receiving, from the second TRP, a second set of reference signals, wherein the second reference signal is one of a strongest reference signal, of the second set of reference signals, or an earliest arriving reference signal, of the second set of reference signals.

29. A method of wireless communication performed by a network node, comprising:
transmitting, to a user equipment (UE), a reference signal configuration associated with a transmission reception point (TRP);
transmitting, to the UE, a reference signal based at least in part on the reference signal configuration; and
receiving, from the UE, a communication, wherein a timing of the communication is based at least in part on a multi-TRP autonomous timing advance adjustment procedure performed by the UE.

30. The method of claim 29, wherein the multi-TRP autonomous timing advance adjustment procedure is associated with a downlink reception timing associated with the TRP and with another downlink reception timing associated with another TRP.
